(19) United States
(12) Patent Application Publication
(10) Pub. No.: US 2026/0221058 A1
(43) Pub. Date: Jul. 30, 2026

(54) Label clip for shelves

(71) Applicant: Xianshi Tang, Foshan (CN)

(72) Inventor: Xianshi Tang, Foshan (CN)

(21) Appl. No.: 19/036,612

(22) Filed: Jan. 24, 2025

(51) Int. Cl. G09F 3/16; G09F 3/20

(52) U.S. Cl. CPC G09F 3/16; G09F 3/204

(57) ABSTRACT

The application discloses a label clip for shelves, belonging to the technical field of storage, comprising a label baffle and a storage plate. The storage plate and the label baffle are inserted into each other, wherein the label baffle comprises a panel, the bottom of the panel is provided with an insertion part, while the end of the insertion part is provided with a supporting part. The inner side wall of the insertion part is provided with a connecting strip, and the side opposite to the supporting part of the panel is equipped with a convex strip. Through the mutual cooperation of the panel, the plug-in part, the supporting part and the convex strip, the label baffle can be quickly installed, and the label baffle adopts a single-layer structure as well, which can save the usage of raw materials and reduce the production cost.

### TECHNICAL FIELD

The invention relates to the technical field of storage, in particular to a label clip for a shelf.

### BACKGROUND TECHNOLOGIES

Shelves are supporting tools for placing goods and an important tool for improving efficiency in modern warehouses. Supermarket shelves are a kind of shelves, which can be used to place goods. In order to let customers have a clear understanding of product information, label holders are usually installed on shelves. With the increase of commodity types, labels in label holders need to be added or replaced frequently.

At present, when common label clips are installed on shelves, double-sided tape is usually attached to the back of the label clips and then fixed with shelves, resulting in inconvenient replacement of the label clips in the later stage. At the same time, the label clips are usually U-shaped structure. When replacing labels, the label clips need to be pulled apart and replaced, which is easy to break over time.

### INVENTION CONTENT

An object of the present invention is to provide a label holder for a shelf in order to solve the problems raised in the above-described background.

In order to achieve the above objective, the present invention provides the following technical solution: a label clip for shelves comprises a label baffle and a storage plate, wherein the storage plate and the label baffle are inserted into each other. The label baffle comprises a panel, the bottom of the panel is provided with a plug part, the end of the plug part is provided with a supporting part, the inner side wall of the plug part is provided with a connecting strip, and the side opposite to the supporting part of the panel is equipped with a convex strip.

Preferably, the supporting part is arranged parallel or perpendicularly to the panel.

Ideally, the convex strip is positioned at the bottom of the panel and is arranged vertically between the panel.

Preferably, the plug-in part has a V-shaped structure.

Optimizedly, the inner peripheral surface of the plug-in part and the cavity surrounded between the convex strip and the supporting portion are insertion channels, and the front side of the storage plate includes insertion strips corresponding to the insertion channels.

Preferably, the top of the panel is provided with a bending section.

Preferably, the label baffle is an integrally molded structure.

Compared with the existing technology, the beneficial effects of the present invention are:

Through the mutual cooperation of the panel, the plug-in part, the supporting part and the convex strip, the label baffle can be directly connected with the storage board by plug-in mode when installing, which is convenient for installation and maintenance and replacement in the later stage. Meanwhile, the label baffle adopts a single-layer structure, which can save the usage of raw materials and reduce the production cost;

By setting the bending section, it is convenient for the staff to add or replace the labels.

### ILLUSTRATION WITH DIAGRAMS

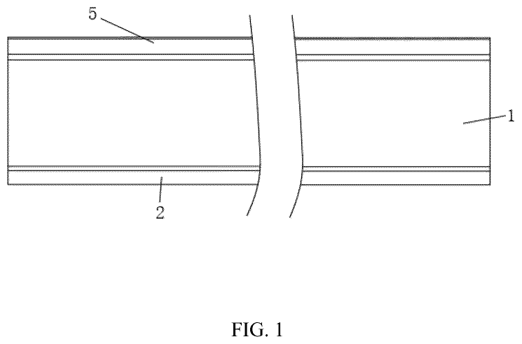

FIG. 1 is a partial schematic view of the entire structure of the present invention;

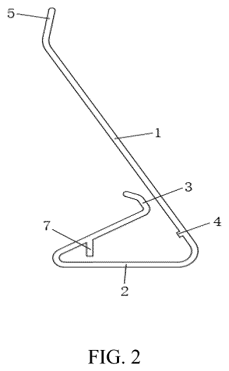

FIG. 2 is a side elevational view of the entire present invention;

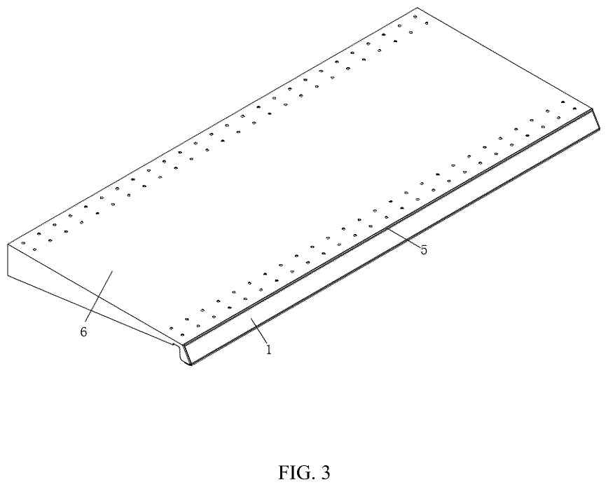

FIG. 3 shows a schematic diagram of a state of use of the present invention.

In the picture:
1. Panel; 2. Plug-in part; 3. Supporting part; 4. Convex strip; 5. Bending part; 6. Storage plate; 7. Connection bar.

### SPECIFIC IMPLEMENTATION METHODS

Hereinafter, the technical solutions in the embodiments of the present invention will be clearly and completely described below in conjunction with the accompanying drawings in the embodiments. Obviously, the described embodiments are only a portion of the embodiments of the present invention, not all embodiments. Based on the embodiments in the present invention, all other embodiments obtained by a person of ordinary skill in this field without making creative labor fall within the scope of protection of the present invention.

Referring to FIGS. 1-3, the present invention provides a technical solution:

As shown in FIG. 1 and FIG. 3, a label clip for shelves comprises a label baffle, and the label baffle is an integral molding structure. The label baffle is made of PVC material, and the label baffle and the storage plate 6 are inserted into each other, the label baffle comprises a panel 1. The bottom of the panel 1 is provided with a plug-in part 2, the transition section between the panel 1 and the plug-in part 2 is in an arc structure, which can avoid the phenomenon of staff scratching during use. The end of the plug-in part 2 is provided with a supporting part 3. The supporting part 3 can be in contact with the storage board 6 after the installation of the label baffle, thereby providing support for the label baffle and avoiding shaking. A connecting strip 7 is equipped on the inner wall of the plug-in part 2, and a protruding strip 4 is provided on the opposite side of the panel 1 and the supporting part 3. With the cooperation of panel 1, plug-in part 2, supporting part 3, and protruding strip 4, it is possible to directly connect the label baffle to the storage board through plug-in method, which is convenient for installation and maintenance and replacement in the later stage. Meanwhile, the label baffle adopts single-layer structure, which can save the usage of raw materials and reduce the production cost.

As shown in FIG. 2, the supporting part 3 is arranged parallel or vertically to the panel 1, that is, the supporting part 3 and the panel 1 have the same inclination. The convex strip 4 is arranged at the bottom of the panel 1 and vertically between the panel 1, wherein the plug-in part 2 has a V-shaped structure, and the inner peripheral surface of the plug-in part 2 and the cavity enclosed between the convex strip 4 and the supporting part 3 are plug channels. So, the plug-in channels and the plug-in strip on the front side of the storage plate 6 can be quickly mounted during installation.

Further, the top of the panel 1 is provided with a bending part 5, and the transition section between the bending part 5 and the panel 1 is an arc structure. The upper part of the bending part 5 is higher than the board surface height of the storage plate 6, and the included angle between the bending part 5 and the panel 1 is an obtuse angle, so that it is convenient for the staff to put the label between the bending part 5 and the storage plate 6, and then insert the label between the panel 1 and the storage plate 6, which is convenient and quick.

Although embodiments of the present invention have been shown and described, it will be appreciated by those of ordinary skill in this field that a variety of changes, modifications, substitutions, and variations may be made to these embodiments without departing from the principle and spirit of the present invention, the scope of which is limited by the appended claims and their equivalents.

1. A label clip for shelves, comprising a label baffle and a storage plate, wherein the storage plate and the label baffle are inserted into each other; It is characterized that the label baffle comprises a panel, the bottom of the panel is provided with a plug-in part, the end of the plug-in part is equipped with a supporting part, a connecting strip is provided on the inner wall of the plug-in part, and a panel is provided with a convex strip on the side opposite to the supporting part.

2. A label clip for shelves according to claim 1, wherein it is characterized in that supporting portion is set parallel or perpendicular to the panel.

3. A label clip for shelves in accordance with claim 1, wherein the convex bar is positioned at the bottom of the panel and is arranged perpendicularly to the panel.

4. A label clip for shelves according to claim 1, it is characterized in that plug-in part has a V-shaped structure.

5. The label clip for shelves in line with claim 4, wherein it is characterized in that the inner peripheral surface of the plug-in part and the cavity enclosed between the convex strip and the supporting part are the plug-in channels, and that the front side of shelf plate has an insertion strip corresponding to the insertion channel.

6. The label clip for shelves according to claim 1, wherein the top of the panel is provided with a bending part.

7. The label clip for shelves in accordance with claim 1, wherein the label baffle has an integrally molded structure.
